(19) United States
(12) Patent Application Publication
(10) Pub. No.: US 2016/0197954 A1
(43) Pub. Date: Jul. 7, 2016

(54) DEFENDING AGAINST FLOW ATTACKS

(71) Applicant: HANGZHOU H3C TECHNOLOGIES CO., LTD., Hangzhou, Zhejiang (CN)

(72) Inventor: Zhonghai LUO, Beijing (CN)

(73) Assignee: Hangzhou H3C Technologies Co., Ltd., Hangzhou (CN)

(21) Appl. No.: 14/903,189

(22) PCT Filed: Sep. 29, 2014
(86) PCT No.: PCT/CN2014/087784

§ 371 Date: Jan. 6, 2016

(30) Foreign Application Priority Data
Sep. 29, 2013 (CN) 201310456642.8

(51) Int. Cl. H04L 29/06

(52) U.S. Cl. CPC H04L 63/1441; H04L 63/1425

(57) ABSTRACT

A network device maintains a sharing token bucket for all sessions in a semi-connection state; a packet is received by the network device; a flow control for the packet is performed by using the sharing token bucket when determining the packet conforms to the semi-connection state; and a flow control for the packet is performed by using a dedicated token bucket of a session corresponding to the packet when determining the packet conforms to a full-connection state.

### BACKGROUND

In operation of a network, sometimes it may happen that a Personal Computer (PC) is infected by viruses or attacked, which may cause a large amount of anomaly traffic to be sent to the network. As a result, a utilization rate of a Central Processing Unit (CPU) of a network device will become too high, or link load will become too high, etc., which may impact the operation of normal services.

### BRIEF DESCRIPTION OF THE DRAWINGS

FIG. 1 is a flow diagram illustrating a method for defending against flow attacks according to an example of the present disclosure.

FIG. 2 is a flow diagram illustrating a method for defending against flow attacks according to another example of the present disclosure.

FIG. 3 is a schematic diagram illustrating a structure of an apparatus for defending against flow attacks according to an example of the present disclosure.

FIG. 4 is a schematic diagram illustrating a structure of a network device according to an example of the present disclosure.

### DETAILED DESCRIPTION

Technical solutions of the present disclosure will be illustrated in detail hereinafter with reference to the accompanying drawings and specific examples.

A session is an information exchange set up between two hosts or end devices. Information relating to the session may be stored in a table in an end device. Examples include but are not limited to a Hyper Text Transfer Protocol (HTTP) session, a Session Initiation Protocol (SIP) session based on an Internet phone call and a Transmission Control Protocol (TCP) session, etc. A session has a state based on whether the session is in the process of being set up or has been fully established by an exchange of messages between the end devices. A semi-connection state is a state in which the session is in the process of being set up. A full connection state is a state in which the session has been fully established.

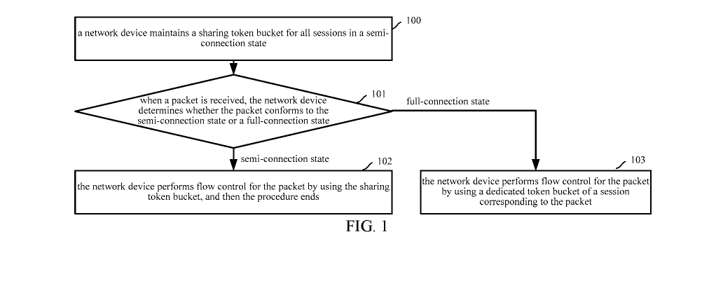

FIG. 1 is a flow diagram illustrating a method for defending against flow attacks according to an example of the present disclosure. As shown in FIG. 1, the method may include the following procedures.

At block 100, a network device maintains a sharing token bucket for all sessions in a semi-connection state.

A size of the sharing token bucket and an adding rate of the token may be determined based on experiences.

At block 101, when a packet is received, the network device determines whether the packet conforms to the semi-connection state or a full-connection state. If it conforms to the semi-connection state, proceed to block 102; if it conforms to the full-connection state, proceed to block 103. Conforms to the semi-connection state means that the packet belongs to a session having a semi-connection state and conforms to the full-connection state means that the packet belongs to a session having a full-connection state.

At block 102, the network device performs a flow control for the packet by using the sharing token bucket, and the procedure ends.

At block 103, the network device performs a flow control for the packet by using a dedicated token bucket of a session corresponding to the packet.

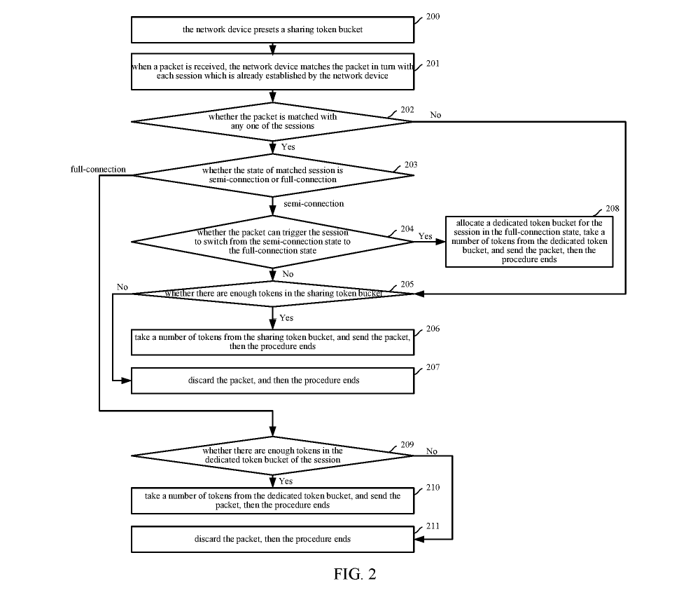

FIG. 2 is a flow diagram illustrating a method for defending against flow attacks according to another example of the present disclosure. As shown in FIG. 2, the method may include the following procedures.

At block 200, a network device maintains a sharing token bucket for all sessions in a semi-connection state.

A size of the sharing token bucket and an adding rate of the token may be determined based on experiences.

At block 201, when a packet is received, the network device compares the packet in turn with each session which is already established by the network device including sessions in the full connection state and sessions in the semi-connection state.

At block 202, the network device determines whether the packet matches with any one of the sessions. If yes, proceed to block 203; otherwise, proceed to block 205.

If the packet matches with none of the sessions, the network device may establish a new session according to the packet, and the state of the new session is semi-connection.

According to one example, a packet matches with a session if it is determined that the packet is from a device and/or port that is one of the two end devices of the session, for instance, if source information and destination information in a header of the packet matches source information and destination information of the two end points of the session.

In one example, the packet matching with a session refers to that a 5-tuple of the packet are consistent with a 5-tuple of a session initiation packet, or contrary to the 5-tuple of the session initiation packet. The 5-tuple of the packet being consistent with the 5-tuple of the session initiation packet refers to that a protocol of the packet is same with a protocol of the session initiation packet, a source address, a source port number of the packet are consistent with a source address, a source port number of the session initiation packet respectively, and a destination address, a destination port number of the packet are consistent with a destination address, a destination port number of the session initiation packet respectively. The 5-tuple of the packet being contrary to 5-tuple of the session initiation packet refers to that the protocol of the packet is same with the protocol of the session initiation packet, a source address, a source port number of the packet are consistent with a destination address, a destination port number of the session initiation packet respectively, and a destination address, a destination port number of the packet are consistent with a source address, a source port number of the session initiation packet respectively.

At block 203, the network device determines whether the state of matched session is semi-connection or full-connection. If it is semi-connection, proceed to block 204; if it is full-connection, proceed to block 209.

At block 204, the network device determines whether the packet can trigger the session to switch from the semi-connection state to the full-connection state. If yes, proceed to block 208; otherwise, proceed to block 205.

When the network device determines that the packet can trigger the session to switch from the semi-connection state to the full-connection state, it may change the state of the session to be full-connection. For example, a TCP session is established by three handshakes. For instance, the three handshakes may be an initiation request from the source, a response from the destination and a confirmation from the source. When a first TCP handshake packet is received, establish a new TCP session, of which the state is semi-connection; when a second TCP handshake packet is received, it may not change the state of the session; when a third TCP handshake packet is received, it may change the state of the session to be full-connection, i.e., the third TCP handshake packet can trigger the state of a TCP session to be switched from the semi-connection state to the full-connection state.

At block 205, the network device determines whether there are enough tokens in the sharing token bucket. If yes, proceed to block 206; otherwise, proceed to block 207.

If the number of tokens in the sharing token bucket is not less than the length of the packet, the network device may allow the packet to pass, i.e., the network device may forward the packet; otherwise, the network device may refuse the packet to pass, i.e., the network device may need to discard the packet.

At block 206, the network device takes a number of tokens from the sharing token bucket, and sends the packet, and then the procedure ends. Wherein, the number of tokens taken from the sharing token bucket by the network device is based on the length of the packet. In one example, the number of tokens taken is equal to the length of the packet. The length of the packet may refer to the total length of a L2 header, an IP header and payload within the packet. The length of the packet may be the number of bits or the number of bytes of the packet. In one example, for a 1024 bit packet including the L2 header, IP header and payload 1024 tokens are taken.

At block 207, the network device discards the packet, and then the procedure ends.

At block 208, the network device allocates a dedicated token bucket for the session in the full-connection state, takes a number of tokens from the dedicated token bucket, and sends the packet, and then the procedure ends. Wherein, the number of tokens taken from the dedicated token bucket by the network device equals to the length of the packet.

A size of the dedicated token bucket and an adding rate of the token may be determined based on experiences.

At block 209, the network device determines whether there are enough tokens in the dedicated token bucket of the session. If yes, proceed to block 210; otherwise, proceed to block 211.

At block 210, the network device takes a number of tokens from the dedicated token bucket, and sends the packet, and then the procedure ends. Wherein, the number of tokens taken from the dedicated token bucket by the network device equals to the length of the packet.

In block 211, the network device discards the packet.

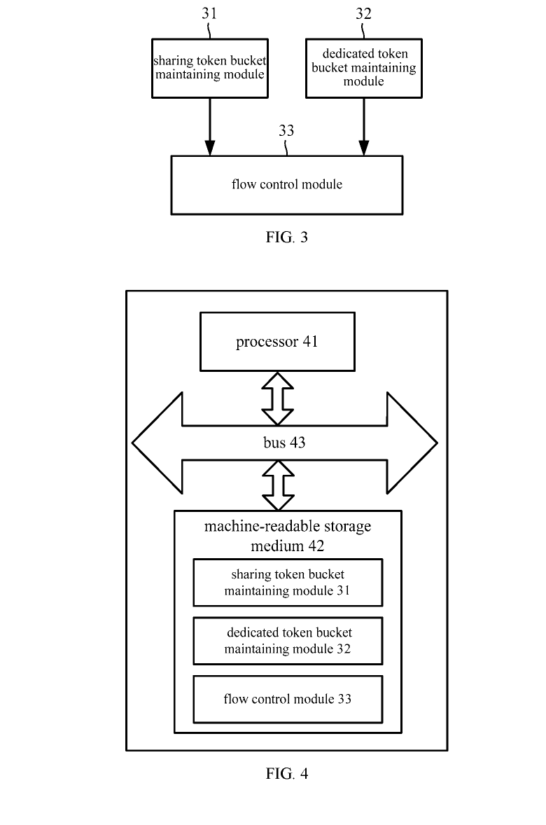

FIG. 3 is a schematic diagram illustrating a structure of an apparatus for defending against flow attacks according to an example of the present disclosure. As shown in FIG. 3, the apparatus includes a sharing token bucket maintaining module 31, a dedicated token bucket maintaining module 32, and a flow control module 33.

The sharing token bucket maintaining module 31 maintains a sharing token bucket for all sessions in semi-connection state.

The dedicated token bucket maintaining module 32 maintains a dedicated token bucket for each session in full-connection states.

When a packet is received, the flow control module 33 determines whether the packet conforms to a semi-connection state or a full-connection state; if determining that the packet conforms to the semi-connection state, the flow control module 33 performs a flow control for the packet by using the sharing token bucket maintained by the sharing token bucket maintaining module 31; and if determining that the packet conforms to the full-connection state, the flow control module 33 performs a flow control for the packet by using the dedicated token bucket maintained by the dedicated token bucket maintaining module 32 for a session corresponding to the packet.

When the flow control module 33 finds that the packet conforms to the semi-connection state, the flow control module 33 may perform a flow control for the packet by using the sharing token bucket maintained by the sharing token bucket maintaining module 31, which may include the following procedures: if determining that the packet is matched with none of the sessions, the flow control module 33 establishes a session in the semi-connection state corresponding to the packet, and further determines whether there are enough tokens in the sharing token bucket maintained by the sharing token bucket maintaining module 31; if yes, the flow control module 33 takes a number of tokens from the sharing token bucket, and sends the packet; otherwise, discards the packet, wherein the number of the tokens taken by the flow control module 33 is equal to the length of the packet. Or, if determining that the packet is matched with a session already established in the semi-connection state, and the packet cannot trigger the session to be switched to the full-connection state, the flow control module 33 determines whether there are enough tokens in the sharing token bucket maintained by the sharing token bucket maintaining module 31; if yes, the flow control module 33 takes a number of tokens from the sharing token bucket, and sends the packet; otherwise, discards the packet. Wherein, the number of the tokens taken by the flow control module 33 is equal to the length of the packet.

When the flow control module 33 finds that the packet conforms to the full-connection state, the flow control module 33 may perform a flow control for the packet by using the dedicated token bucket maintained by the dedicated token bucket maintaining module 32 for a session corresponding to the packet, which may include the following procedures: if determining that the packet is matched with a session already established in the semi-connection state, and the packet can trigger the session to be switched to the full-connection state, the flow control module 33 allocates a dedicated token bucket for the session in the full-connection state in the dedicated token bucket maintaining module 32, takes a number of tokens from the dedicated token bucket, and sends the packet, wherein the number of the tokens taken by the flow control module 33 is equal to the length of the packet. Or, if determining that the packet is matched with a session already established in the full-connection state, the flow control module 33 determines whether there are enough tokens in the dedicated token bucket maintained for the session by the dedicated token bucket maintaining module 32; if yes, the flow control module 33 takes a corresponding token from the sharing token bucket, and sends the packet; otherwise, discarding the packet, wherein the number of the tokens taken by the flow control module 33 is equal to the length of the packet.

FIG. 4 is a schematic diagram illustrating a structure of a network device according to another example of the present disclosure. The network device may include: a processor 41, a non-transitory machine-readable storage medium 42, and a bus 43. The processor 41 and the machine-readable storage medium 42 are connected by the bus 43.

The processor 41 is configured to execute modules of machine-readable instructions stored in the machine-readable storage medium 42.

The machine-readable storage medium 42 is configured to store the machine-readable instruction modules executed by the processor 41. The modules executed by the processor 41 may include: a sharing token bucket maintaining module 31, a dedicated token bucket maintaining module 32, and a flow control module 33. When executed by the processor 41, the sharing token bucket maintaining module 31 may maintain a sharing token bucket for all sessions in the semi-connection state; the dedicated token bucket maintaining module 32 may maintain a dedicated token bucket for each session in the full-connection state; the flow control module 33 may, when a packet is received, if determining that the packet conforms to the semi-connection state, perform flow control for the packet by using the maintained sharing token bucket; if determining that the packet conforms to the full-connection state, perform flow control for the packet by using the maintained dedicated token bucket for a session corresponding to the packet.

When determining that the packet conforms to the semi-connection state, performing flow control for the packet by using the maintained sharing token bucket may include: if determining that the packet is matched with none of the sessions, establishing a session in the semi-connection state corresponding to the packet, and determining whether there are enough tokens in the maintained sharing token bucket; if yes, taking a number of tokens from the sharing token bucket, and sending the packet; otherwise, discarding the packet; or, if determining that the packet is matched with a session already established in the semi-connection state, and the packet cannot trigger the session to be switched to the full-connection state, determining whether there are enough tokens in the maintained sharing token bucket; if yes, taking a number of tokens from the sharing token bucket, and sending the packet; otherwise, discarding the packet. Wherein, the number of the tokens taken by the flow control module 33 is equal to the length of the packet.

When determining that the packet conforms to the full-connection state, performing flow control for the packet by using the maintained dedicated token bucket for a session corresponding to the packet may include: if determining that the packet is matched with a session already established in the semi-connection state, and the packet can trigger the session to be switched to the full-connection state, allocating a dedicated token bucket for the session in the full-connection state, taking a number of tokens from the dedicated token bucket, and sending the packet; or, if determining that the packet is matched with a session already established in the full-connection state, determining whether there are enough tokens in the dedicated token bucket maintained for the session; if yes, taking a number of tokens from the sharing token bucket, and sending the packet; otherwise, discarding the packet. Wherein, the number of the tokens taken by the flow control module 33 is equal to the length of the packet.

In this case, the instructions read from the storage medium can implement the functions of any of the aforementioned examples, and therefore, the instructions and the machine-readable storage medium storing the instructions constitute a part of the present disclosure.

A non-transitory “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

Thus, it can be seen that by performing flow control for the session in the semi-connection state by using the sharing token bucket, and by performing flow control for the session in the full-connection state by using the dedicated token bucket, the flow attacks with a fixed source or a fixed destination may be defended against, and the flow attacks with a varying source or a varying destination may also be defended against.

The foregoing is preferred examples of the present disclosure, which is not intended to limit the present disclosure. Any modifications, equivalents, and improvements made within the spirit and principle of the present disclosure should be covered by the scope of the present disclosure.

What is claimed is:

1. A method for defending against flow attacks, comprising:
maintaining, by a network device, a sharing token bucket for all sessions in a semi-connection state;
receiving, by the network device, a packet;
determining whether the packet conforms to a semi-connection state or a full-connection state;
performing, by the network device, a flow control for the packet by using the sharing token bucket in response to determining the packet conforms to the semi-connection state; and
performing, by the network device, a flow control for the packet by using a dedicated token bucket of a session corresponding to the packet in response to determining the packet conforms to a full-connection state.

2. The method according to claim 1, wherein performing the flow control for the packet by using the sharing token bucket comprises:
establishing a session in the semi-connection state corresponding to the packet when determining the packet is matched with none of the sessions already established by the network device;
determining whether there are enough tokens in the sharing token bucket, taking a number of tokens from the sharing token bucket and sending the packet when there are enough tokens in the sharing token bucket, wherein the number of tokens taken equals to the length of the packet; or discarding the packet when there are not enough tokens in the sharing token bucket.

3. The method according to claim 1, wherein performing the flow control for the packet by using the sharing token bucket comprises:
determining whether there are enough tokens in the sharing token bucket when determining the packet is matched with a session in the semi-connection state already established by the network device and the packet cannot trigger the session to be switched to the full-connection state, taking a number of tokens from the sharing token bucket, and sending the packet when there are enough tokens in the sharing token bucket, wherein the number of tokens taken equals to the length of the packet; or
discarding the packet when there are not enough tokens in the sharing token bucket.

4. The method according to claim 1, wherein performing the flow control for the packet by using the dedicated token bucket of a session corresponding to the packet comprises:
allocating a dedicated token bucket for the session in the full-connection state when determining the packet is matched with a session in the semi-connection state already established by the network device, and the packet can trigger the session to be switched to the full-connection state; and
taking a number of tokens from the dedicated token bucket and sending the packet, wherein the number of tokens taken equals to the length of the packet.

5. The method according to claim 1, wherein performing the flow control for the packet by using the dedicated token bucket of a session corresponding to the packet comprises:
determining whether there are enough tokens in the dedicated token bucket of the session when determining the packet is matched with a session in the full-connection state already established by the network device,
taking a number of tokens from the dedicated token bucket and sending the packet when there are enough tokens in the dedicated token bucket; wherein the number of tokens taken equals to the length of the packet; or
discarding the packet when there are not enough tokens in the dedicated token bucket.

6. A network device to defend against flow attacks, comprising: a processor and a non-transitory storage medium storing machine-readable instructions those are executable by the processor to:
maintain a sharing token bucket for all sessions in a semi-connection state;
receive a packet;
determine whether the packet conforms to a semi-connection state or a full-connection state;
perform a flow control for the packet by using the sharing token bucket in response to determining the packet conforms to the semi-connection state; and
perform a flow control for the packet by using a dedicated token bucket of a session corresponding to the packet in response to determining the packet conforms to a full-connection state.

7. The network device according to claim 6, wherein the machine-readable instructions are executable by the processor to:
establish a session in the semi-connection state corresponding to the packet when determining the packet is matched with none of the sessions already established by the network device;
determine whether there are enough tokens in the sharing token bucket, take a number of tokens from the sharing token bucket and send the packet when there are enough tokens in the sharing token bucket, wherein the number of tokens taken equals to the length of the packet; or
discard the packet when there are not enough tokens in the sharing token bucket.

8. The network device according to claim 6, wherein the machine-readable instructions are executable by the processor to:
determine whether there are enough tokens in the sharing token bucket when determining the packet is matched with a session in the semi-connection state already established by the network device and the packet cannot trigger the session to be switched to the full-connection state,
take a number of tokens from the sharing token bucket and send the packet when there are enough tokens in the sharing token bucket, wherein the number of tokens taken equals to the length of the packet; or
discard the packet when there are not enough tokens in the sharing token bucket.

9. The network device according to claim 6, wherein the machine-readable instructions are executable by the processor to:
allocate a dedicated token bucket for the session in the full-connection state when determining the packet is matched with a session in the semi-connection state already established by the network device, and the packet can trigger the session to be switched to the full-connection state; and
take a number of tokens from the dedicated token bucket and send the packet, wherein the number of tokens taken equals to the length of the packet.

10. The network device according to claim 6, wherein the machine-readable instructions are executable by the processor to:
determine whether there are enough tokens in the dedicated token bucket of the session when determining the packet is matched with a session in the full-connection state already established by the network device,
take a number of tokens from the dedicated token bucket and send the packet when there are enough tokens in the dedicated token bucket; wherein the number of tokens taken equals to the length of the packet; or
discard the packet when there are not enough tokens in the dedicated token bucket.

11. A non-transitory storage medium, storing machine-readable instructions executable by a processor to defend against flow attacks, the instructions comprising instructions to:
maintain a sharing token bucket for all sessions in a semi-connection state;
receive a packet;
determine whether the packet conforms to a semi-connection state or a full-connection state;
perform a flow control for the packet by using the sharing token bucket in response to determining the packet conforms to the semi-connection state; and
perform a flow control for the packet by using a dedicated token bucket of a session corresponding to the packet in response to determining the packet conforms to a full-connection state.

12. The non-transitory storage medium according to claim 11, wherein, the non-transitory storage medium stores machine-readable instructions executable by a machine to:
establish a session in the semi-connection state corresponding to the packet when determining the packet is matched with none of the sessions already established by the network device;
determine whether there are enough tokens in the sharing token bucket,
take a number of tokens from the sharing token bucket and send the packet when there are enough tokens in the sharing token bucket, wherein the number of tokens taken equals to the length of the packet; or
discard the packet when there are not enough tokens in the sharing token bucket.

13. The non-transitory storage medium according to claim 11, wherein, the non-transitory storage medium stores machine-readable instructions executable by a machine to:
determine whether there are enough tokens in the sharing token bucket when determining the packet is matched with a session in the semi-connection state already established by the network device and the packet cannot trigger the session to be switched to the full-connection state,
take a number of tokens from the sharing token bucket and send the packet when there are enough tokens in the sharing token bucket, wherein the number of tokens taken equals to the length of the packet; or
discard the packet when there are not enough tokens in the sharing token bucket.

14. The non-transitory storage medium according to claim 11, wherein, the non-transitory storage medium stores machine-readable instructions executable by a machine to:
allocate a dedicated token bucket for the session in the full-connection state when determining the packet is matched with a session in the semi-connection state already established by the network device, and the packet can trigger the session to be switched to the full-connection state; and
take a number of tokens from the dedicated token bucket and send the packet, wherein the number of tokens taken equals to the length of the packet.

15. The non-transitory storage medium according to claim 11, wherein, the non-transitory storage medium stores machine-readable instructions executable by a machine to:
determine whether there are enough tokens in the dedicated token bucket of the session when determining the packet is matched with a session in the full-connection state already established by the network device,
take a number of tokens from the dedicated token bucket and send the packet when there are enough tokens in the dedicated token bucket; wherein the number of tokens taken equals to the length of the packet; or
discard the packet when there are not enough tokens in the dedicated token bucket.
